(19) United States
(12) Patent Application Publication
(10) Pub. No.: US 2015/0154681 A1
(43) Pub. Date: Jun. 4, 2015

(54) ENRICHING PRODUCT CATALOG WITH PRODUCT NAME KEYWORDS

(71) Applicant: Microsoft Corporation, Redmond, WA (US)

(72) Inventors: Raghu Ram, Redmond, WA (US); Kaushik Chakrabarti, Redmond, WA (US); Meera Mahabala, Redmond, WA (US); Navid Azimi-Garakani, Redmond, WA (US); Tao Cheng, Redmond, WA (US); Yeye He, Redmond, WA (US)

(73) Assignee: Microsoft Corporation, Redmond, WA (US)

(21) Appl. No.: 14/253,479

(22) Filed: Apr. 15, 2014

Related U.S. Application Data
(60) Provisional application No. 61/911,254, filed on Dec. 3, 2013.

(51) Int. Cl. G06Q 30/06

(52) U.S. Cl. CPC G06Q 30/0625

(57) ABSTRACT

A keyword generator identifies words or phrases of interest in a product catalog and also identifies synonyms for the words or phrases of interest. The synonyms are integrated into the product catalog to generate an enriched product catalog. The level of co-occurrence of synonyms between sets of product catalog entries is identified and, if it meets a threshold level, the product names from the catalog entries are integrated into the other catalog entries in the set, as synonyms.

### CROSS-REFERENCE TO RELATED APPLICATION

The present application is based on and claims the benefit of U.S. provisional patent application Ser. No. 61/911,254, filed Dec. 3, 2013, the content of which is hereby incorporated by reference in its entirety.

### BACKGROUND

Computer systems are currently in wide use. Some such computer systems allow users to search for items, such as products.

Business computer systems can include enterprise resource planning (ERP) systems, customer relations management (CRM) systems, line-of-business (LOB) systems, retail systems, among others. Some business systems provide the functionality that enables a retail store to have an online storefront (or web storefront). The functionality on such a storefront allows a user to access the online storefront using a computing device. Such storefronts also often allow the user to browse through products offered by the retail store and to make online purchases. In addition, such systems can be deployed at the point-of-sale (POS) for a brick and mortar retail store, or in other environments such as kiosks and call centers.

Regardless of where the (or electronic) storefront is deployed, it often includes search functionality. The search functionality allows a user to input search keywords, or queries, to look for products or services in a product catalog for the store. A search engine searches through a product catalog index to identify product catalog entries that match the query and that can be returned to the user in the form of search results (such as a list of links to the underlying catalog entries, or such as the catalog entries themselves.

When users attempt to use the search functionality, they may not use the exact same terms that are used to index the product catalog. Therefore, the search result set returned by the search engine may be missing relevant products. For instance, a user, searching for a camera, may input the search terms “single lens reflex camera”. However, the user may not know that the search terms “SLR camera” are synonymous with “single lens reflex camera”. Thus, the catalog search engine can fail to return a match, where the terms “SLR camera” are indexed, as opposed to the terms “single lens reflex camera”.

Also, some users may search for brand name products, but the product catalog may not have that brand. Instead, the retail store may carry an equivalent product but it may be generic, or of a different brand.

The discussion above is merely provided for general background information and is not intended to be used as an aid in determining the scope of the claimed subject matter.

### SUMMARY

A keyword generator identifies words or phrases of interest in a product catalog and also identifies synonyms for the words or phrases of interest. The synonyms are integrated into the product catalog to generate an enriched product catalog. The level of co-occurrence of synonyms between sets of product catalog entries is identified and, if it meets a threshold level, the product names from the catalog entries are integrated into the other catalog entries in the set, as synonyms.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of one illustrative catalog generation architecture.

FIG. 2 is a flow diagram illustrating one embodiment of the overall operation of the architecture shown in FIG. 1 in generating and deploying an enriched product catalog.

FIG. 2A shows one example of a product catalog entry.

FIG. 3 is a flow diagram illustrating one embodiment of the operation of the architecture shown in FIG. 1 in augmenting the enriched product catalog with product names.

FIG. 3A shows one embodiment of a set of product catalog entries.

FIG. 4 shows one embodiment of the architecture shown in FIG. 1, deployed in a cloud computing architecture.

FIG. 5-9 show various embodiments of mobile devices.

FIG. 10 is a block diagram of one illustrative computing environment.

### DETAILED DESCRIPTION

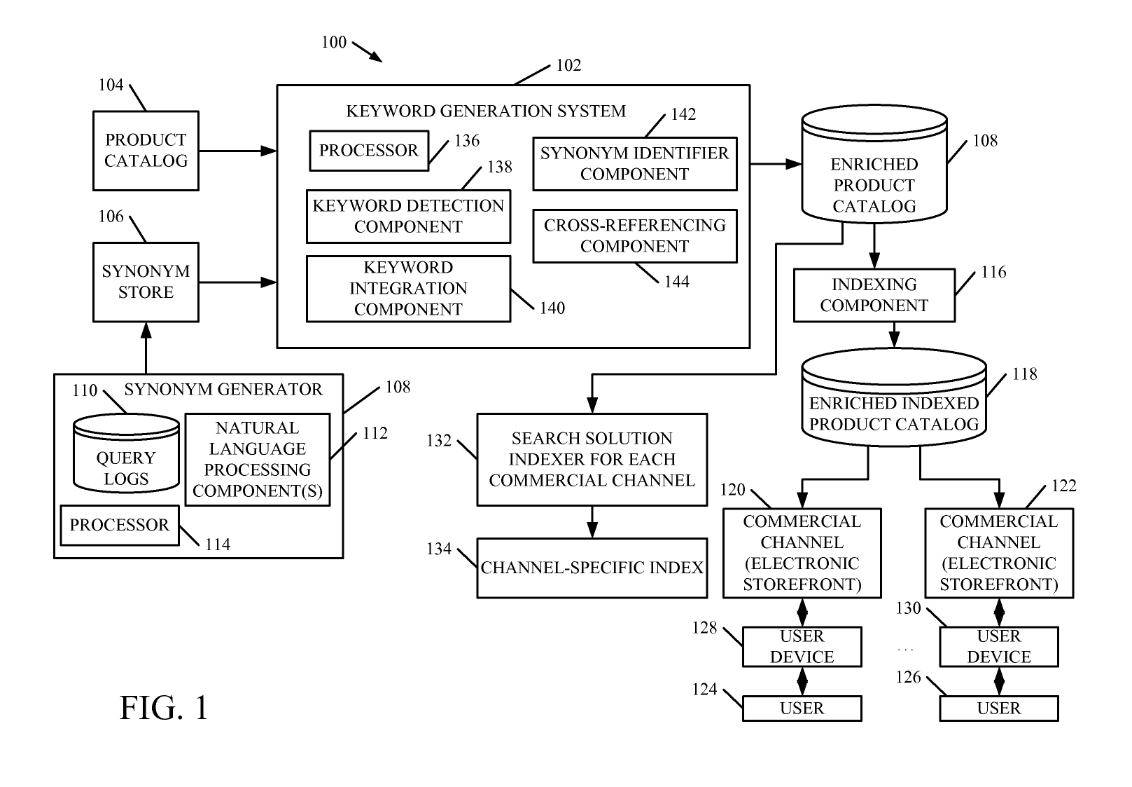

FIG. 1 is a block diagram of one illustrative catalog generation architecture 100. Architecture 100 illustratively includes keyword generation system 102 that has access to product catalog 104 and synonym store 106. Keyword generation system 102 is shown generating enriched product catalog 108, which is illustratively an enriched version of product catalog 104. FIG. 1 also shows that synonym store 106 can be generated by synonym store generator 108. Synonym store generator 108 illustratively includes a set of query logs 110, natural language processing components 112 and processor 114. One embodiment of the generation of synonym store 106 is described in more detail below.

FIG. 1 also shows that enriched product catalog 108 can be indexed by a channel-independent indexing component 116 to generate enriched, indexed product catalog 118. Catalog 118 can then be provided to various commercial channels (where it can be deployed in electronic storefronts) in channels 120-122. The electronic storefronts in channels 120-122 can include such things as a web storefront, a point-of-sale (POS) solution, or a variety of other commercial channels. The commercial channels 120-122 are shown being accessed by end users 124-126 through user devices 128-130.

In another embodiment, enriched product catalog 108 can be provided to the search solutions for each commercial channel 120-122, before it is indexed. The search solutions each can include a channel-specific indexer 132 which can generate a channel-specific index 134 of enriched product catalog 108. It will also be noted that, in another embodiment, channel-independent indexing component 116 can be used to generate a channel-independent index for enriched product catalog 108, and channel-specific indexers 132 can also be used to generate channel-specific indexes 134. Thus, the present discussion contemplates that either channel-independent indexing component 116 or channel-specific indexing components 132 can be used, or both can be used. Other indexing schemes can be used as well.

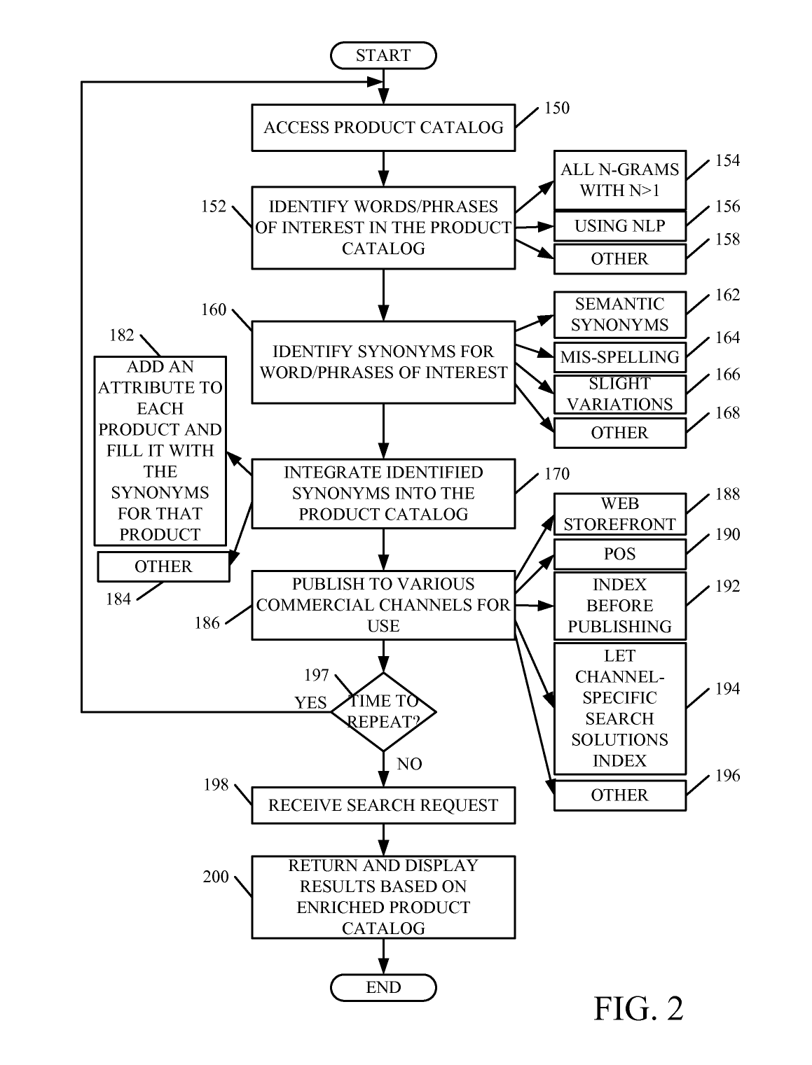

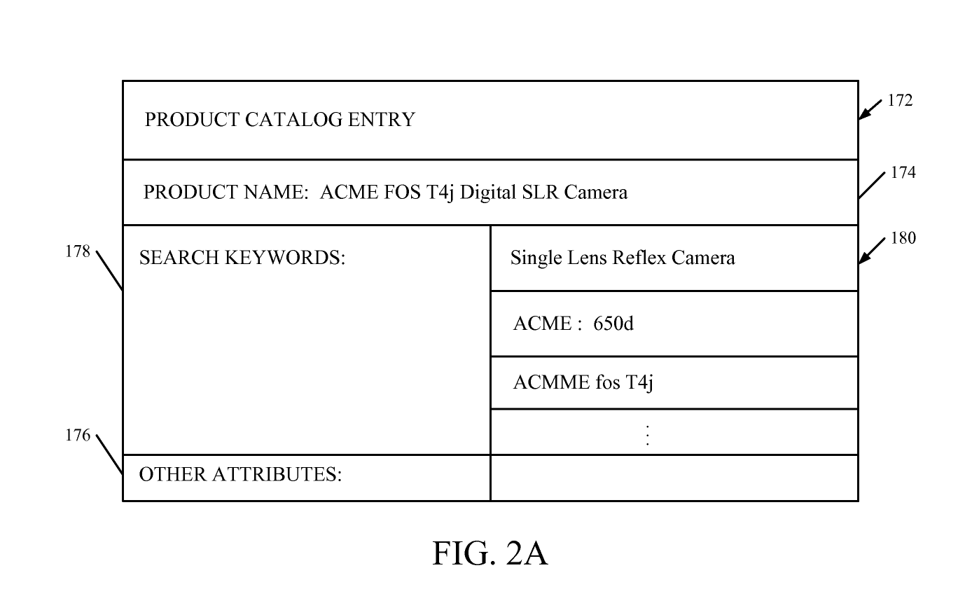

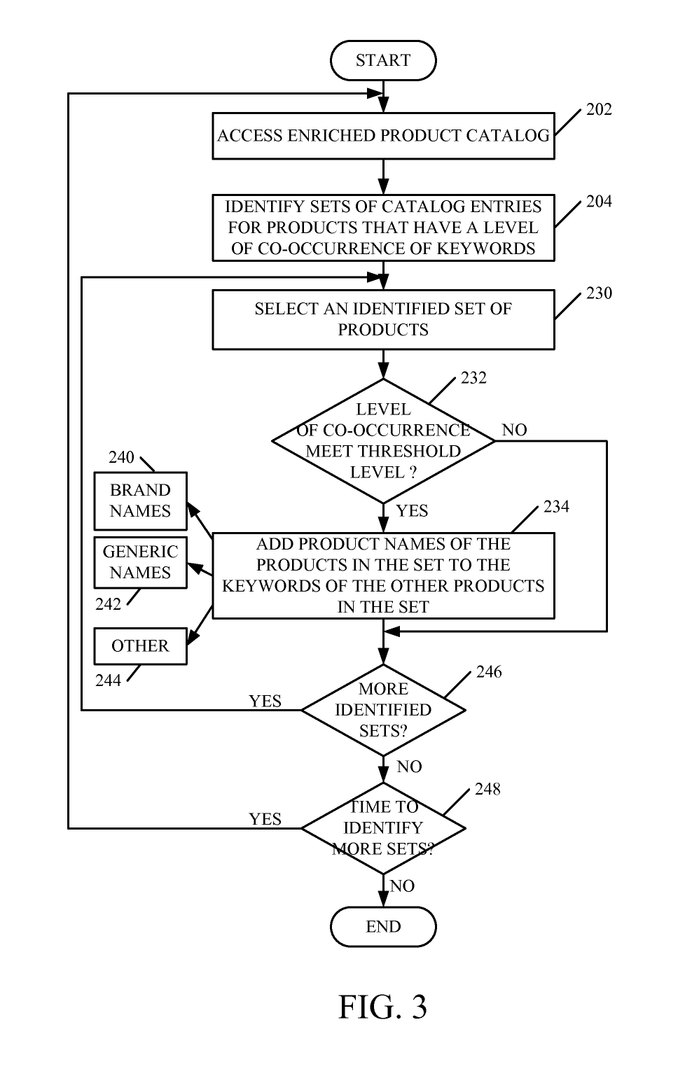

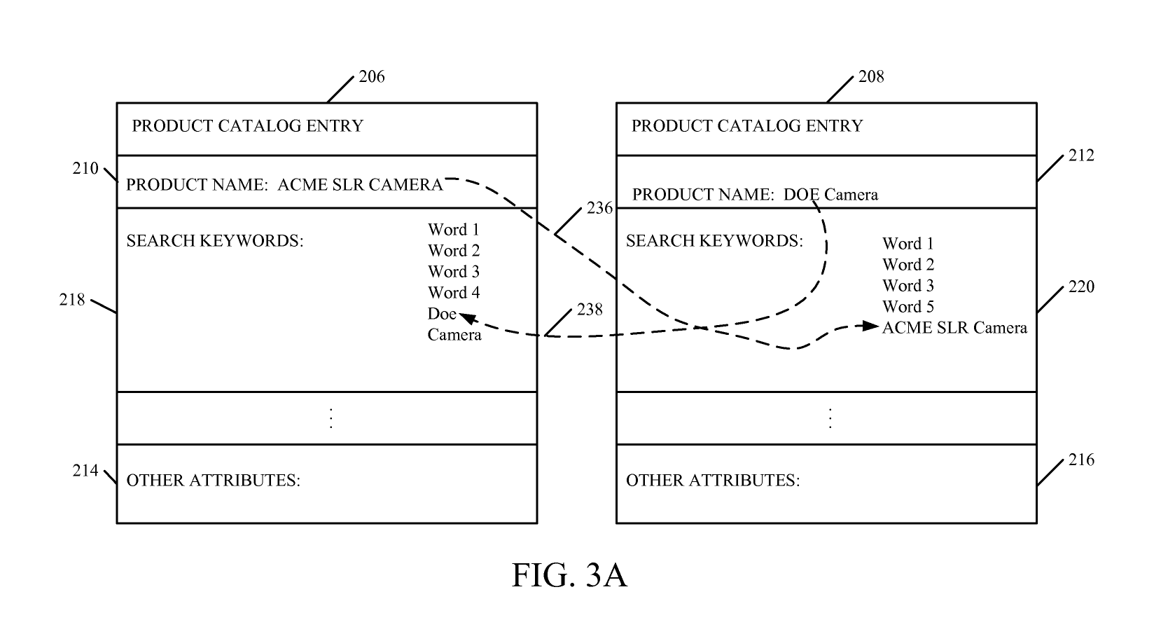

Keyword generation system 102 illustratively includes processor 136, keyword detection component 138, keyword integration component 140, synonym identifier component 142 and cross-reference component 144. The operation of architecture 100 is described in more detail below with respect to FIGS. 2 and 3. Briefly, however, keyword detection component 138 detects keywords in product catalog 104. Synonym identifier component 142 identifies synonyms for the identified keywords, from synonym store 106. Keyword integration component 140 then integrates the identified synonyms into the product catalog entries for given products. This can be used as enriched product catalog 108. In another embodiment, cross-referencing component 144 identifies co-occurrences in the keywords in sets of records in enriched product catalog 108 and further enriches the search keywords to include the product names for products for which a sufficient level of keyword co-occurrence already exists. This is described in greater detail below with respect to FIG. 3.

FIG. 2 is a flow diagram illustrating one embodiment of the operation of architecture 100 shown in FIG. 1 in generating enriched product catalog 108. Keyword detection component 138 first accesses product catalog 104, which is to be enriched. Accessing product catalog 104 is indicated by block 150 in FIG. 2.

Keyword detection component 138 then identifies linguistic units (e.g., words or phrases) of interest in product catalog 104. This is indicated by block 152 in FIG. 2, and it can be done in a variety of different ways. In one embodiment, product catalog 104 illustratively has catalog entries that specify the products in a canonical form. For instance, assume that one of the entries in the product catalog includes a product name “ACME FOST4J Digital SLR Camera”. Keyword detection component 138 thus identifies words or phrases of interest in that catalog entry. In order to do so, keyword detection component 138 can employ one or more of a variety of different techniques for identifying the words or phrases of interest. For instance, keyword detection component 138 can enumerate all n-grams (e.g., where n>1) as the words or phrases of interest in the product name. This is indicated by block 154 in FIG. 2. In another embodiment, or in addition, keyword detection component 138 can use natural language processing components. For instance, the natural language processing components can identify noun phrases in the product catalog entry or other semantic or syntactic elements of interest. Using natural language processing to detect the words or phrases of interest in the catalog entry is indicated by block 156. Of course, other mechanisms or techniques can be used to identify the words or phrases of interest as well, and this is indicated by block 158.

Continuing with the example discussed above, it is assumed that keyword detection component 138 has identified the phrases “ACME FOST4J” and “Digital SLR Camera” as the words or phrases of interest in product entry mentioned above.

Synonym identifier component 142 then identifies synonyms for the words or phrases of interest that were detected by keyword detection component 138. This is indicated by block 160 in FIG. 2. In one embodiment, synonym store 106 stores a thesaurus of synonyms for its entries. The synonym store 106 can for instance, include common misspellings, names with slight variations, semantic synonyms, among other things. Semantic synonyms are indicated by block 162. Misspellings are indicated by block 164, names with slight variations are indicated by block 166, and other synonyms are indicated by block 168. Thus, synonym identifier component 142 accesses synonym store 106 to look up synonyms for each of the identified words or phrases of interest. By way of example, synonym store 106 may have the phrase “single lens reflex camera” as a synonym for “digital SLR camera”. It may also have the synonyms “ACME 650D” and “ACMME FOST4J” as synonyms for the phrase of interest “ACME FOST4J”.

Keyword integration component 140 then generates enriched product catalog 108 by integrating the synonyms identified by synonym identifier component 142 into the product catalog entry, for this product, in product catalog 104. Integrating the identified synonyms into the product catalog is indicated by block 170 in the flow diagram of FIG. 2. This can be done in a variety of different ways as well. For instance, keyword integration component 140 can introduce a new attribute into each entry in the product catalog. The new attribute can be, for example, the attribute “search keywords”. The new attribute can have, as its value, all of the identified synonyms for the words and phrases of interest identified for that product catalog entry.

FIG. 2A shows one simplified embodiment of an exemplary, product catalog entry 172. It can be seen that entry 172 illustratively includes a product name section 174 that includes the example name “ACME FOST4J Digital SLR Camera”. Product catalog entry 172 can include a variety of other attributes 176 as well. FIG. 2A also shoes that, in one embodiment, product catalog entry 172 has had the “search keywords” attribute 178 added to it. The value for that attribute includes the synonyms “single lens reflex camera”, “ACME 650D”, and “ACMME FOST4J”. The values are for the search keywords attribute 178 are generally indicated by numeral 180. Adding the attribute to each product entry and filling it with the synonyms for that product is indicated by block 182 in the flow diagram of FIG. 2. Of course, the identified synonyms can be integrated into the product catalog in other ways as well, and this is indicated by block 184.

Keyword generation system 102 then publishes the enriched product catalog 108 to the various commercial channels, for use. This is indicated by block 186 in FIG. 2. The commercial channels can include web storefront 188, point-of-sale channel 190, or other channels. In addition, it can be seen that enriched product catalog 108 can be indexed by channel-independent indexing component 116, before enriched product catalog 108 is published to the commercial channels 120-122. This is indicated by block 192 in the flow diagram of FIG. 2. It can also be seen that enriched product catalog 108 can simply be published to the various commercial channels 120-122, so that the channel-specific indexers 132 can index the enriched product catalog 108 in a channel-specific way. This is indicated by block 194. The indexing can be performed in other ways as well, and this is indicated by block 196.

As will be described below, synonym generator 108 may periodically or intermittently update synonym store 106. It may also be that product catalog 104 is intermittently updated. When that occurs, keyword detection component 138 can repeat the process of identifying any new words or phrases of interest for the updated catalog 104. Synonym identifier component 142 can also access the updated synonym store 106 to identify whether any new synonyms are identified. Determining whether it is time to repeat the process described above with respect to FIG. 2 is indicated by block 197 in FIG. 2. If so, processing reverts to block 150. If not, the published enriched product catalog 108 can be used in the various commercial channels.

In any case, once the enriched product catalog 108 is deployed at the various commercial channels 120-122, it can be used by end users 124-126. Therefore, the search solutions in the various commercial channels can receive search requests as indicated by block 198 in FIG. 2. They can also then return and display search results based on the enriched product catalog 108, as indexed. This is indicated by block 200 in FIG. 2.

In some environments, different retail stores do not carry every single brand of a given product. However, they may carry substantially equivalent products to those that they do not carry. By way of example, it may be that a retailer carries an ACME brand smartphone, but does not carry a Contoso brand smartphone, although the two are substantially equivalent in their functionality, or in other ways. It may be that the retailer wishes to return the equivalent (or similar) ACME product when the user searches for the Contoso product. In addition, the retailer may carry a variety of different generic brand products that are also substantially equivalent. The retailer may wish to return those generic brand products as well.

FIG. 3 shows a flow diagram illustrating an embodiment of the operation of architecture 100 in determining whether product catalog entries meet a cross reference criterion and, if so, cross referencing product names in the various product catalog entries. The cross reference criterion discussed is a level of co-occurrence of search keywords, but this is only one exemplary cross reference criterion and others can be used. It will be appreciated that the operations in FIG. 3 can be carried out within the context of the flow diagram of FIG. 2, or they can be done separately. They are described separately with respect to FIG. 3 for the sake of example only.

Cross-reference component 144 first accesses enriched product catalog 108. This is indicated by block 202 in FIG. 3. Cross-reference component 144 then identifies sets of products in catalog 108 that have a level of co-occurrence of keywords. This is indicated by block 204. For instance, cross-reference component 144 can identify all sets of products in catalog 108 that have any keywords in common. Cross-reference component 144 then determines whether any of those sets of catalog entries have a level of co-occurrence between their sets of keywords that meets a threshold level.

More specifically, FIG. 3A shows a set of product catalog entries 206 and 208. Each entry illustratively has a product name section 210 and 212, respectively. They also have additional attributes 214 and 216, respectively. FIG. 3A also shows that each catalog entry 206 and 208 has been enriched with a keywords attribute section 218 and 220, respectively. It can be seen that catalog entry 206 is for a product named “ACME SLR Camera”. Keyword generation system 102 has identified four keywords (word 1, word 2, word 3, and word 4) as words or phrases of interest for entry 206, and included them in keywords attribute section 218.

FIG. 3A also shows that product catalog entry 208 is for a product that has a product name “DOE Camera”. System 102 has identified keywords (word 1, word 2, word 3, and word 5) and inserted those into the keywords attribute section 220 of entry 208. Thus, cross-reference component 144 identifies entries 206 and 208 as a set of entries that have some common keywords in their keywords attribute sections 218 and 220. That is, they have the common keywords word 1, word 2 and word 3. Cross reference component 144 identifies all sets of catalog entries with some common keywords.

Cross-reference component 144 then selects one of those sets for further processing. Selecting an identified set of entries is indicated by block 230 in the flow diagram of FIG. 3.

Cross-reference component 144 then determines whether the level of co-occurrence of the keywords in the selected set of records 206 and 208 meets a threshold level. This is indicated by block 232. The threshold level can be set in a wide variety of ways. For instance, it can be set anecdotally, heuristically, or it can be set statistically, based upon statistical algorithms that can be used to identify the appropriate level of co-occurrence. It can also change based upon the specific product to which the catalog entries correspond, or it can be changed based upon the different subject matter areas of the product catalogs, themselves. These are examples only.

If the level of co-occurrence does meet the threshold level, then the product names of the product catalog entries 206 and 208 are added to the keywords attribute section 218 and 220 of the other product catalog entry in the set. This is indicated by block 234 in the flow diagram of FIG. 3. For instance, and referring again to FIG. 3A, if cross-reference component 144 determines that the level of co-occurrence between the keywords for the entries 206 and 208 does meet the threshold level, then cross-reference component 144 adds the product name of product catalog entry 206 (i.e., “ACME SLR Camera”) to the keywords section 220 of product catalog entry 208. This is indicated by dashed arrow 236 in FIG. 3A. In addition, cross-reference component 144 adds the product name from product catalog entry 208 (i.e., “DOE Camera”) to the keywords section 218 of product catalog entry 206. This is indicated by dashed arrow 238 in FIG. 3A. This can have the effect of adding brand name products to the keywords section of other products. This is indicated by block 240 in the flow diagram of FIG. 3. It can also have the effect of adding generic names to the keywords section of brand name products. This is indicated by block 242 in FIG. 3. It can also, of course, add the product names for other products to those of the other product catalog entries in the set. This is indicated by block 244 in FIG. 3.

Cross-reference component 144 can perform these operations of augmenting product catalog entries with the product names of other entries for each of the sets, for which the co-occurrence of keywords meets the threshold level. This is indicated by block 246 in FIG. 3.

It will also be noted that, as the product catalog entries are further enriched based upon additions or changes to synonym source 106 (as described above with respect to FIG. 2), cross-reference component 144 can intermittently repeat the processing of the enriched product catalog 108 to perform cross referencing as described with respect to FIG. 3. Intermittently repeating the process is indicated by block 248 in FIG. 3.

In yet another embodiment, the product names may already be identified as synonyms for one another in synonym store 106. In that case, cross-reference component 104 can either access synonym store 106 and perform the above-described processing, or the product names can be included in enriched product catalog 108 by synonym identifier 142 during the processing described above with respect to FIG. 2.

While synonym store 106 can be obtained in a wide variety of different ways, one exemplary way of obtaining synonym store 106 will now be described. In the embodiment shown in FIG. 1, synonym store generator 108 illustratively has access to query logs 110. Query logs 110 illustratively include a log of queries by a variety of different users using a search engine. The queries in logs 110 have illustratively been identified as queries where the user is searching for a product. Query logs 110 not only store the queries themselves, but also the returned results, and the click through data which identifies the various results that the user selected for further review. Query logs 110 can include a variety of other information as well.

Natural language processing components 112 illustratively process the query logs 110 to identify synonyms. For instance, if the user enters the terms “single lens reflex cameral” and clicks on a variety of results that show “SLR camera”, then natural language processing components 112 can identify “single lens reflex” and “SLR” as synonyms. The identified synonyms are thus stored in synonym store 106 where “SLR” will appear as a synonym for “single lens reflex”, and vice versa.

The present discussion has mentioned processors and servers. In one embodiment, the processors and servers include computer processors with associated memory and timing circuitry, not separately shown. They are functional parts of the systems or devices to which they belong and are activated by, and facilitate the functionality of the other components or items in those systems.

Also, a number of user interface displays have been discussed. They can take a wide variety of different forms and can have a wide variety of different user actuatable input mechanisms disposed thereon. For instance, the user actuatable input mechanisms can be text boxes, check boxes, icons, links, drop-down menus, search boxes, etc. They can also be actuated in a wide variety of different ways. For instance, they can be actuated using a point and click device (such as a track ball or mouse). They can be actuated using hardware buttons, switches, a joystick or keyboard, thumb switches or thumb pads, etc. They can also be actuated using a virtual keyboard or other virtual actuators. In addition, where the screen on which they are displayed is a touch sensitive screen, they can be actuated using touch gestures. Also, where the device that displays them has speech recognition components, they can be actuated using speech commands.

A number of data stores have also been discussed. It will be noted they can each be broken into multiple data stores. All can be local to the systems accessing them, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

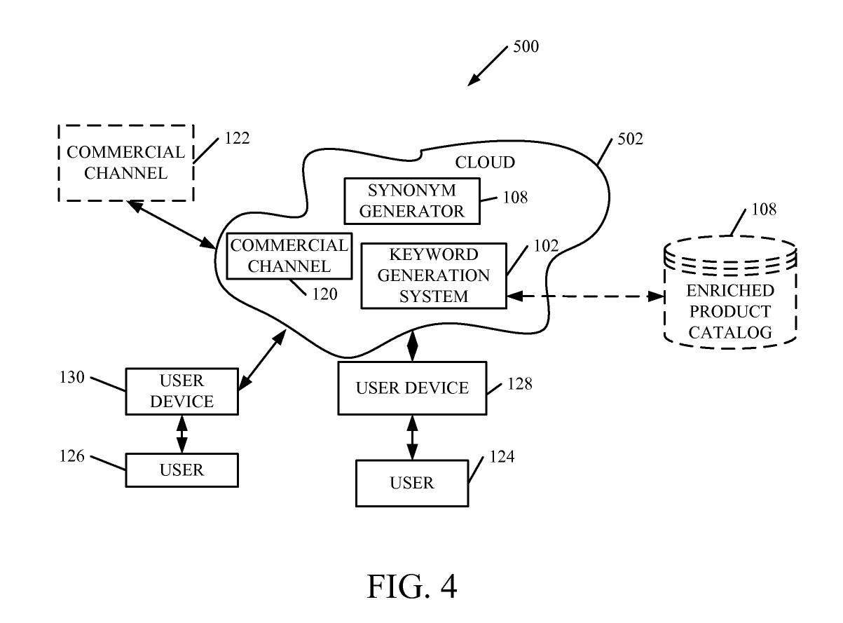

FIG. 4 is a block diagram of architecture 100, shown in FIG. 1, except that its elements are disposed in a cloud computing architecture 500. Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of architecture 100 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

In the embodiment shown in FIG. 4, some items are similar to those shown in FIG. 1 and they are similarly numbered. FIG. 4 specifically shows that synonym generator 108, keyword generator system 102 and commercial channel 120 can be located in cloud 502 (which can be public, private, or a combination where portions are public while others are private). Therefore, users 124 and 126 use user devices 128 and 130 to access those systems through cloud 502.

FIG. 4 also depicts another embodiment of a cloud architecture. FIG. 4 shows that it is also contemplated that some elements of architecture 100 can be disposed in cloud 502 while others are not. By way of example, data store 108 and commercial channel 122 (or other items of architecture 100) can be disposed outside of cloud 502, and accessed through cloud 502. Regardless of where they are located, they can be accessed directly by devices 128 and 130, through a network (either a wide area network or a local area network), they can be hosted at a remote site by a service, or they can be provided as a service through a cloud or accessed by a connection service that resides in the cloud. All of these architectures are contemplated herein.

It will also be noted that architecture 100, or portions of it, can be disposed on a wide variety of different devices. Some of those devices include servers, desktop computers, laptop computers, tablet computers, or other mobile devices, such as palm top computers, cell phones, smart phones, multimedia players, personal digital assistants, etc.

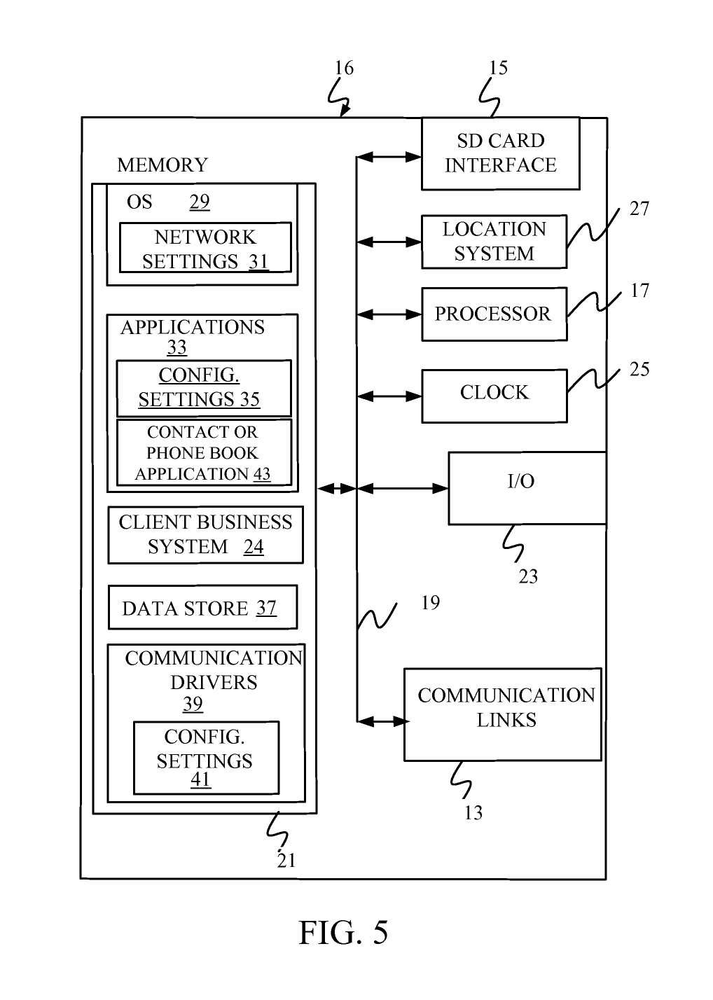

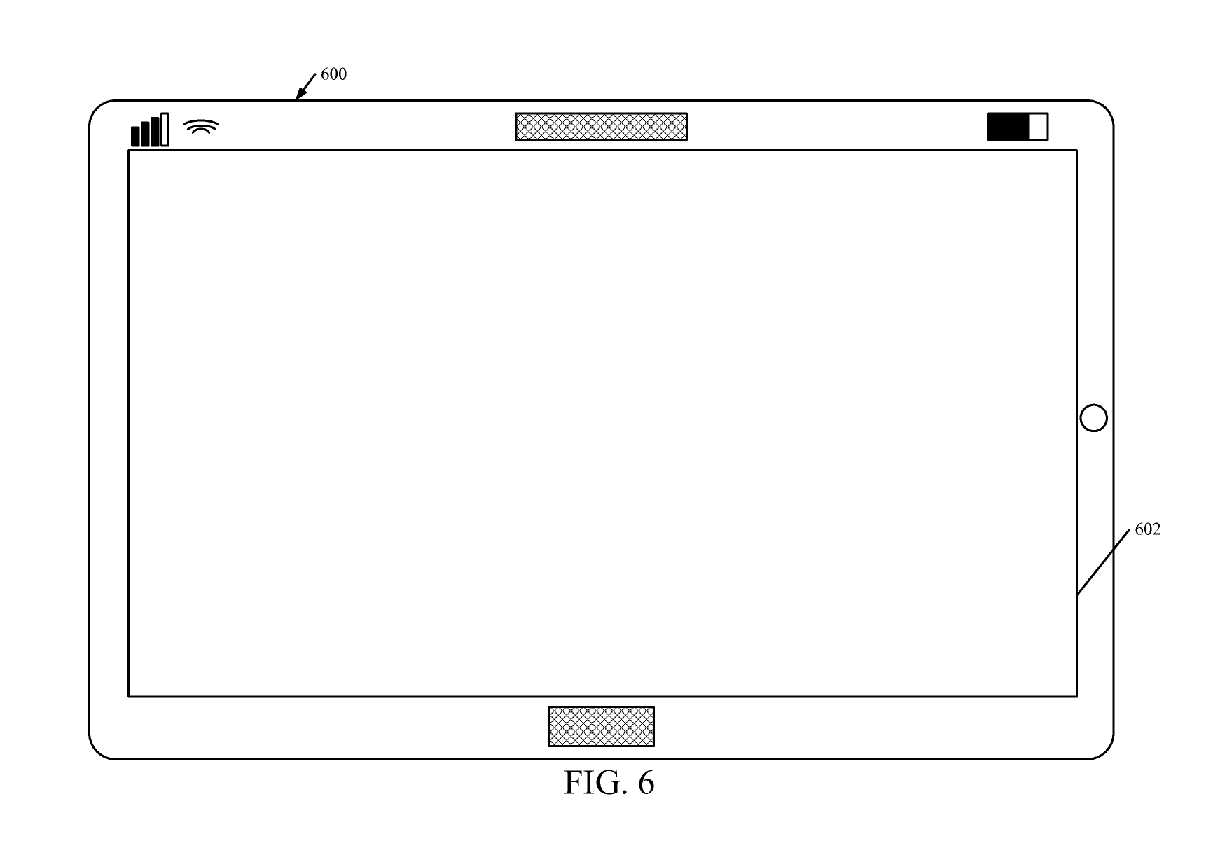

FIG. 5 is a simplified block diagram of one illustrative embodiment of a handheld or mobile computing device that can be used as a user's or client's hand held device 16, in which the present system (or parts of it) can be deployed. FIGS. 6-9 are examples of handheld or mobile devices.

FIG. 5 provides a general block diagram of the components of a client device 16 that can run components of architecture 100 or that interacts with architecture 100, or both. In the device 16, a communications link 13 is provided that allows the handheld device to communicate with other computing devices and under some embodiments provides a channel for receiving information automatically, such as by scanning. Examples of communications link 13 include an infrared port, a serial/USB port, a cable network port such as an Ethernet port, and a wireless network port allowing communication though one or more communication protocols including General Packet Radio Service (GPRS), LTE, HSPA, HSPA+ and other 3G and 4G radio protocols, 1Xrtt, and Short Message Service, which are wireless services used to provide cellular access to a network, as well as 802.11 and 802.11b (Wi-Fi) protocols, and Bluetooth protocol, which provide local wireless connections to networks.

Under other embodiments, applications or systems are received on a removable Secure Digital (SD) card that is connected to a SD card interface 15. SD card interface 15 and communication links 13 communicate with a processor 17 (which can also embody processors 114 or 136 from FIG. 1) along a bus 19 that is also connected to memory 21 and input/output (I/O) components 23, as well as clock 25 and location system 27.

I/O components 23, in one embodiment, are provided to facilitate input and output operations. I/O components 23 for various embodiments of the device 16 can include input components such as buttons, touch sensors, multi-touch sensors, optical or video sensors, voice sensors, touch screens, proximity sensors, microphones, tilt sensors, and gravity switches and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions. Processor 17 can be activated by other components to facilitate their functionality as well.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can be applications that have previously been stored on the device 16 or applications that are installed during use, although these can be part of operating system 29, or hosted external to device 16, as well.

FIG. 6 shows one embodiment in which device 16 is a tablet computer 600. In FIG. 6, computer 600 is shown with display screen 602. Screen 602 can be a touch screen (so touch gestures from a user's finger can be used to interact with the application) or a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. Computer 600 can also illustratively receive voice inputs as well.

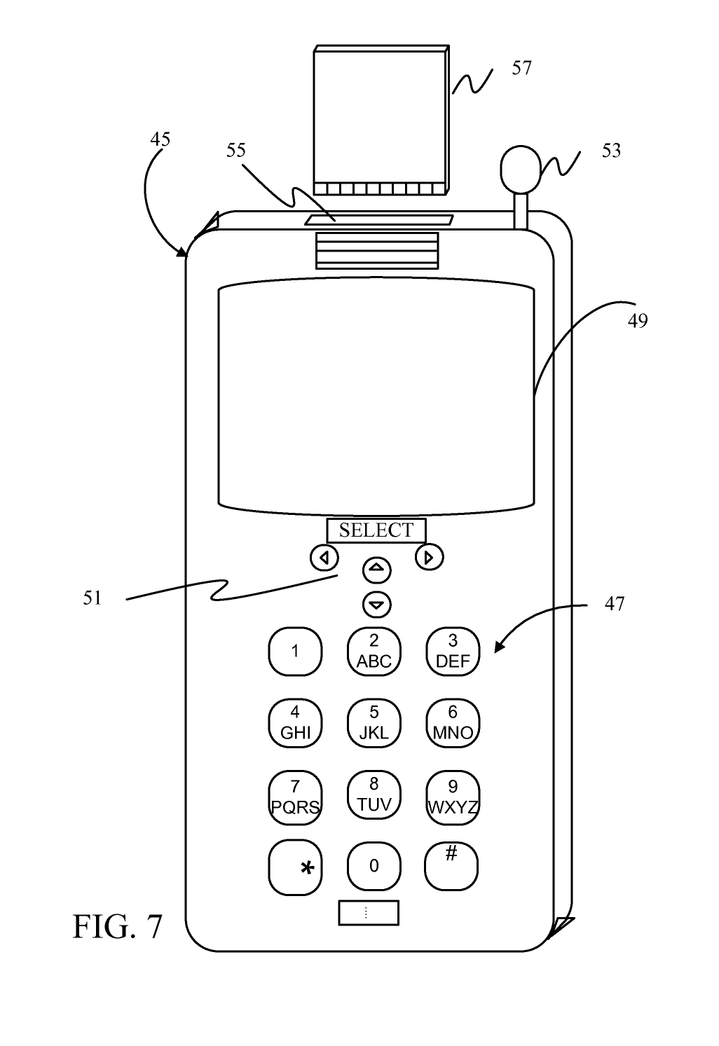

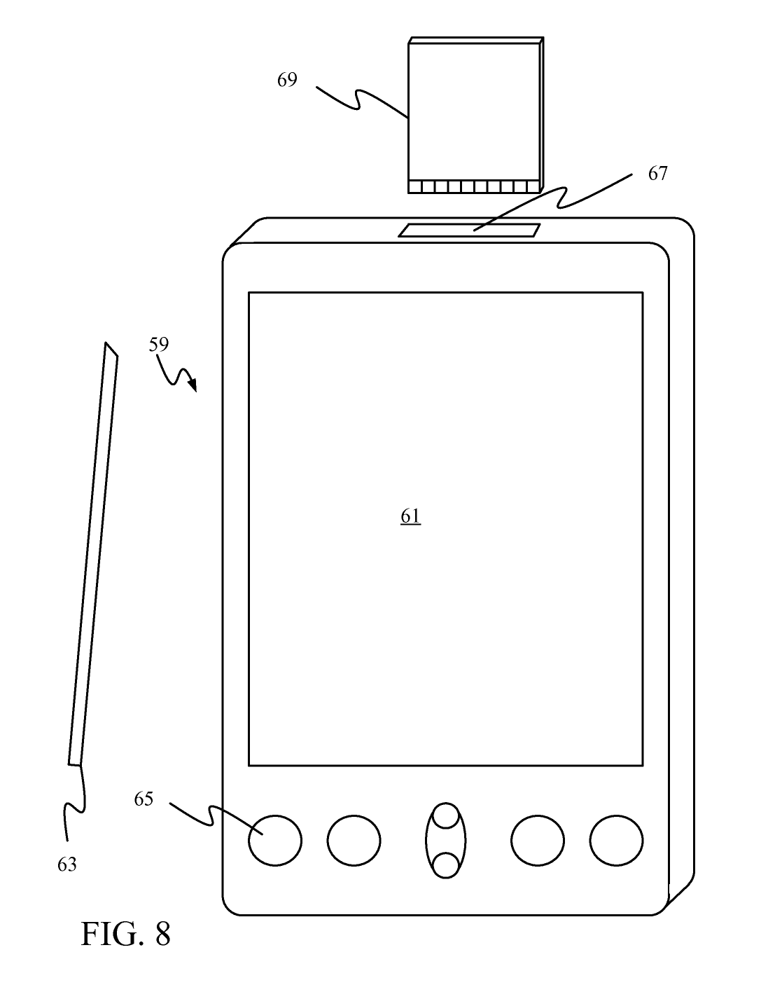

FIGS. 7 and 8 provide additional examples of devices 16 that can be used, although others can be used as well. In FIG. 7, a feature phone, smart phone or mobile phone 45 is provided as the device 16. Phone 45 includes a set of keypads 47 for dialing phone numbers, a display 49 capable of displaying images including application images, icons, web pages, photographs, and video, and control buttons 51 for selecting items shown on the display. The phone includes an antenna 53 for receiving cellular phone signals such as General Packet Radio Service (GPRS) and 1Xrtt, and Short Message Service (SMS) signals. In some embodiments, phone 45 also includes a Secure Digital (SD) card slot 55 that accepts a SD card 57.

The mobile device of FIG. 8 is a personal digital assistant (PDA) 59 or a multimedia player or a tablet computing device, etc. (hereinafter referred to as PDA 59). PDA 59 includes an inductive screen 61 that senses the position of a stylus 63 (or other pointers, such as a user's finger) when the stylus is positioned over the screen. This allows the user to select, highlight, and move items on the screen as well as draw and write. PDA 59 also includes a number of user input keys or buttons (such as button 65) which allow the user to scroll through menu options or other display options which are displayed on display 61, and allow the user to change applications or select user input functions, without contacting display 61. Although not shown, PDA 59 can include an internal antenna and an infrared transmitter/receiver that allow for wireless communication with other computers as well as connection ports that allow for hardware connections to other computing devices. Such hardware connections are typically made through a cradle that connects to the other computer through a serial or USB port. As such, these connections are non-network connections. In one embodiment, mobile device 59 also includes a SD card slot 67 that accepts a SD card 69.

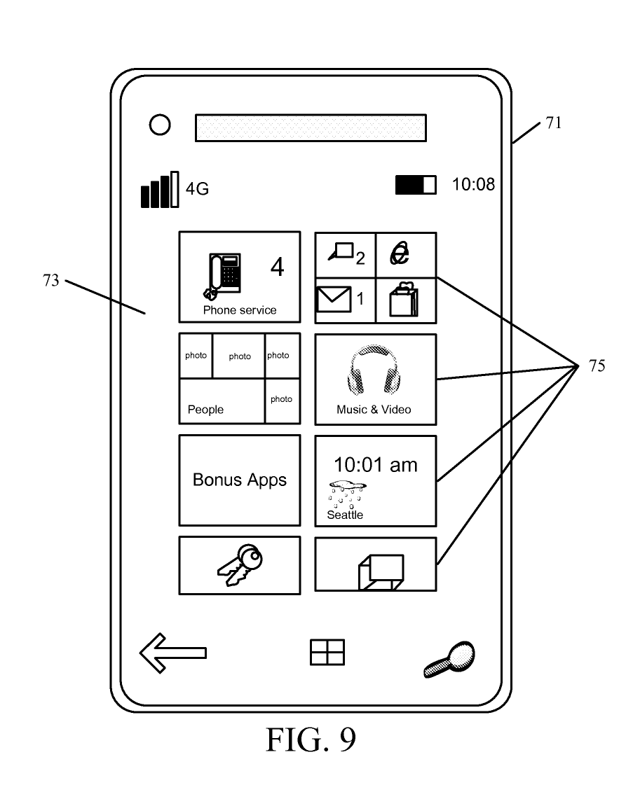

FIG. 9 is similar to FIG. 7 except that the phone is a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone.

Note that other forms of the devices 16 are possible.

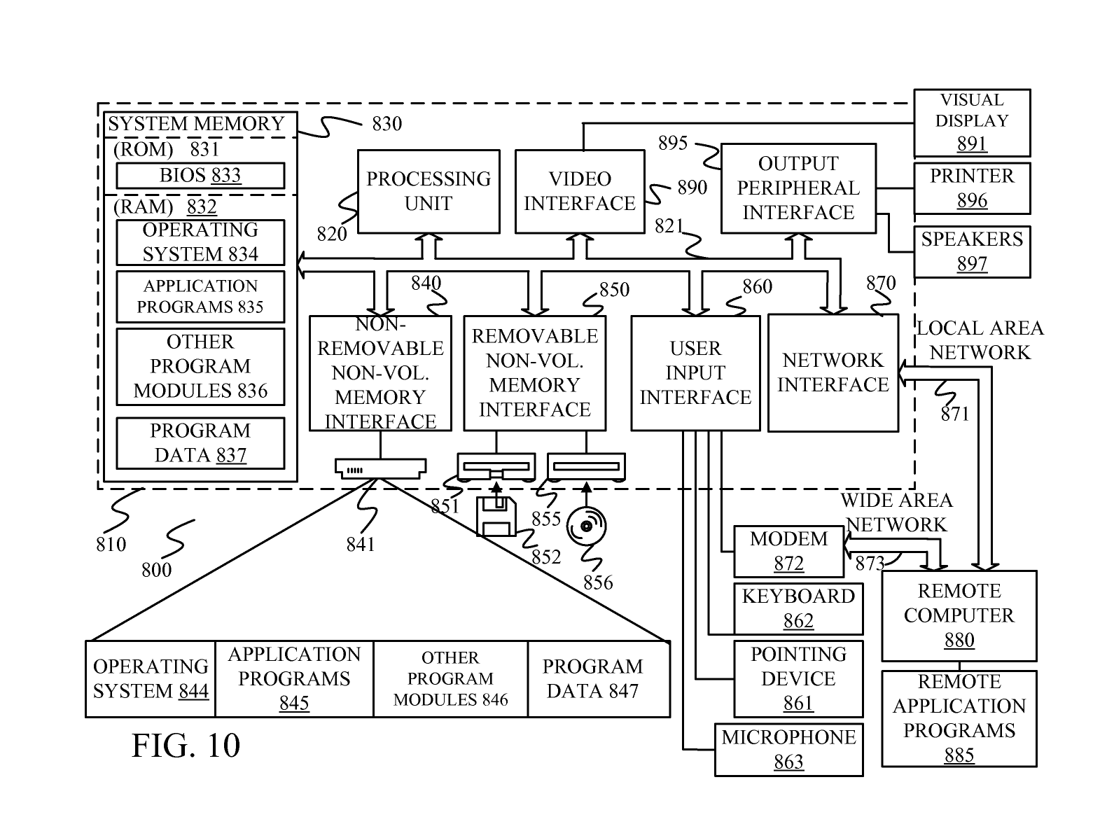

FIG. 10 is one embodiment of a computing environment in which architecture 100, or parts of it, (for example) can be deployed. With reference to FIG. 10, an exemplary system for implementing some embodiments includes a general-purpose computing device in the form of a computer 810. Components of computer 810 may include, but are not limited to, a processing unit 820 (which can comprise processor 114 or 136), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 1 can be deployed in corresponding portions of FIG. 10.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 10 illustrates operating system 834, application programs 835, other program modules 836, and program data 837.

The computer 810 may also include other removable/non-removable volatile/nonvolatile computer storage media. By way of example only, FIG. 10 illustrates a hard disk drive 841 that reads from or writes to non-removable, nonvolatile magnetic media, a magnetic disk drive 851 that reads from or writes to a removable, nonvolatile magnetic disk 852, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and magnetic disk drive 851 and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The drives and their associated computer storage media discussed above and illustrated in FIG. 10, provide storage of computer readable instructions, data structures, program modules and other data for the computer 810. In FIG. 10, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 10 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 10 illustrates remote application programs 885 as residing on remote computer 880. It will be appreciated that the network connections shown are exemplary and other means of establishing a communications link between the computers may be used.

It should also be noted that the different embodiments described herein can be combined in different ways. That is, parts of one or more embodiments can be combined with parts of one or more other embodiments. All of this is contemplated herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A computer-implemented method, comprising:
identifying a first product catalog entry with a first product name and a second product catalog entry with a second product name;
determining whether the first and second product catalog entries meet a cross reference criterion; and
if so, cross referencing the first product catalog entry with the second product catalog entry and cross referencing the second product catalog entry with the first product catalog entry.

2. The computer-implemented method of claim 1 wherein cross referencing comprises:
adding the first product name to the second product catalog entry and adding the second product name to the first product catalog entry to obtain a modified product catalog.

3. The computer-implemented method of claim 2 and further comprising:
outputting the modified catalog for access by a plurality of different commercial channels.

4. The computer-implemented method of claim 2 wherein the first and second catalog entries each include a search keyword portion with searchable linguistic units, and wherein determining whether the first and second product catalog entries meet a cross reference criterion comprises:
determining whether the first and second product catalog entries have any co-occurrence of the searchable linguistic units.

5. The computer-implemented method of claim 4 wherein determining whether the first and second product catalog entries meet a cross reference criterion comprises:
determining whether the first and second product catalog entries have a threshold level of co-occurrence of the searchable linguistic units.

6. The computer-implemented method of claim 4 wherein adding comprises:
adding the first product name to the search keyword portion of the second product catalog entry and adding the second product name to the searchable keyword portion of the first product catalog entry.

7. The computer-implemented method of claim 6 and further comprising:
identifying the searchable keyword linguistic units for the first and second product catalog entries based on the first and second product names; and
adding the identified searchable keyword linguistic units to the search keyword portion of the first and second product catalog entries, respectively.

8. The computer-implemented method of claim 2 wherein the first product catalog entry is for a product having a brand name and the second product catalog entry is for a product having a generic name.

9. The computer-implemented method of claim 8 wherein adding comprises:
adding the generic name to the product catalog entry for the product having the brand name and adding the brand name to the product catalog entry for the product having the generic name.

10. A computer system, comprising:
a cross referencing component that identifies a first product catalog entry with a first product name and a second product catalog entry with a second product name and determines whether the first and second product catalog entries meet a cross reference criterion;
an integration component that, when the first and second product catalog entries meet the cross reference criterion, cross references the first product catalog entry in the second product catalog entry and cross references the second product catalog entry in the first product catalog entry; and
a computer processor that is a functional part of the system and is activated by the cross referencing component and the integration component to facilitate identifying the first and second product catalog entries, determining whether the cross reference criterion is met and, if so, cross referencing.

11. The computer system of claim 10 wherein the integration component cross references by adding the first product name to the second product catalog entry and adding the second product name to the first product catalog entry to obtain a modified product catalog.

12. The computer system of claim 11 and further comprising:
an indexing component that indexes the modified product catalog for use by a plurality of different commercial channels.

13. The computer system of claim 11 wherein the integration component cross references by adding the first product name as a searchable keyword attribute of the second product catalog entry and adding the second product name as a searchable keyword attribute of the first product catalog entry.

14. The computer system of claim 13 wherein the modified product catalog comprises a set of catalog entries with generic name products having generic named catalog entries that are cross referenced with brand name catalog entries for brand name products.

15. The computer system of claim 11 wherein the first and second catalog entries each include a search keyword portion with searchable linguistic units, and wherein the cross referencing component determines whether the first and second product catalog entries meet a cross reference criterion by determining whether the first and second product catalog entries have any co-occurrence of the searchable linguistic units.

16. The computer system of claim 15 wherein the cross referencing component determines whether the first and second product catalog entries meet a cross reference criterion by determining whether the first and second product catalog entries have a threshold level of co-occurrence of the searchable linguistic units.

17. A computer readable storage medium that stores computer readable instructions which, when executed by a computer, cause the computer to perform a method, comprising:
identifying a first product catalog entry with a first product name and a second product catalog entry with a second product name;
determining whether the first and second product catalog entries meet a cross reference criterion; and
if so, adding the first product name to the second product catalog entry and adding the second product name to the first product catalog entry to obtain a modified product catalog.

18. The computer readable storage medium of claim 17 wherein the first and second catalog entries each include a search keyword portion with searchable linguistic units, and wherein determining whether the first and second product catalog entries meet a cross reference criterion comprises:
determining whether the first and second product catalog entries have any co-occurrence of the searchable linguistic units.

19. The computer readable storage medium of claim 18 wherein determining whether the first and second product catalog entries meet a cross reference criterion comprises:
determining whether the first and second product catalog entries have a threshold level of co-occurrence of the searchable linguistic units and wherein adding comprises adding the first product name to the search keyword portion of the second product catalog entry and adding the second product name to the searchable keyword portion of the first product catalog entry.

20. The computer readable storage medium of claim 19 and further comprising:
outputting the modified catalog for access by a plurality of different commercial channels.
